(19) United States
(12) Patent Application Publication
(10) Pub. No.: US 2021/0168133 A1
(43) Pub. Date: Jun. 3, 2021

(54) IDENTITY PROVIDER THAT SUPPORTS MULTIPLE PERSONAS FOR A SINGLE USER

(71) Applicant: MICROSOFT TECHNOLOGY LICENSING, LLC, Redmond, WA (US)

(72) Inventors: Amit Ranjan Kumar, Redmond, WA (US); Mamta Debnath Kumar, Redmond, WA (US); Meghan Taylor King, Redmond, WA (US)

(21) Appl. No.: 16/700,658

(22) Filed: Dec. 2, 2019

(51) Int. Cl. H04L 29/06

(52) U.S. Cl. CPC H04L 63/0815; H04L 63/123

(57) ABSTRACT

Using a persona as an identity of a user when the user interacts with one or more service providers. An identity of a user who is to interact with various service providers is verified. Various different personas related to the identity of the user are accessed. Each individual persona of the different personas includes user information related to the identity of the user. A specific one of the various different personas is selected for use in interacting with a service provider. The selected persona is provided to thereby enable the user to interact with the service provider using the selected persona.

### BACKGROUND

Identity management service includes the task of controlling information about users of various computing systems, including digital identities. Digital identity is an entity's online presence that may encompass personal identifying information and ancillary information (e.g., metadata). It may include the codification of identity names and attributes of a physical instance in a way that facilitates processing. Such information may include information that authenticates the identity of a user, and information that describes data and actions they are authorized to access and/or perform. It may also include the management of descriptive information about the user and how and by whom that information can be accessed and/or modified. Managed entities may include users, hardware devices, software applications, and/or network resources.

For example, identity management service can involve various service functions, such as providing personalized, role-based, online, on-demand, content, and/or presence-based services to users and their devices. Identity management can also involve identity federation, such as relying on federated identity to authenticate a user without knowing his or her password. A federated identity in information technology is the means of linking a person's various digital identities and attributes, which may be stored across multiple distinct identity management services.

In a federated identity management service, various policies, practices, and protocols may be implemented for exchanging authentication and authorization data between parties. For example, Security Assertion Markup Language (SAML) is an XML-based markup language for security assertions that service providers may use to make access-control decisions. As another example, OpenID Connect (OIDC) is another protocol that allows computing clients to verify the identity of an end-user based on the authentication performed by an authorization server.

In conventional identity management services, however, when a user wants to separate data sent to an application, program, or website, he or she may must use a separate user account that is typically under the control of an entity other than the user. Typical identity providers, such as those that use OIDC, provide only one user profile and a limited set of fine grained permissions. This creates challenges for authentication as the user either must keep separate credentials for each user account, or must use the same user account and must remember the profile differences some other manual way.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One embodiment disclosed herein is related to computing systems, computer program products, and methods for using a persona as an identity of a user when the user interacts with one or more service providers. In the embodiment an identity of a user who is to interact with various service providers is verified. Various different personas related to the identity of the user are accessed. Each individual persona of the different personas includes user information related to the identity of the user. A specific one of the various different personas is selected for use in interacting with a service provider. The selected persona is provided to thereby enable the user to interact with the service provider using the selected persona.

Another embodiment disclosed herein is related to computing systems, computer program products, and methods for generating one or more personas related to an identity of a user for use when the user interacts with one or more service providers. In the embodiment, different personas are generated that are to be used by a user when interacting with various service providers. Each of the different personas are related to an identity of the user. For each individual persona of the different personas, user information related to the user that is to be included in the individual persona is selected.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing system in which the principles described herein may be employed;

FIG. 2A illustrates an example computing system according to the embodiments disclosed herein;

FIG. 2B illustrates an alternative view of the computing system of FIG. 2A;

FIG. 2C illustrates an alternative view of the computing system of FIG. 2A;

FIG. 2D illustrates an alternative view of the computing system of FIG. 2A;

FIG. 3 illustrates an example embodiment of a user interface for generating the various personas and linking the personas to various service providers;

FIG. 4 illustrates an example embodiment of a user interface for selecting which personas to use when interacting with a service provider;

FIG. 5 illustrates a flow chart for an example method for using a persona as an identity of a user when the user interacts with one or more service providers; and

FIG. 6 illustrates a flow chart for an example method for generating one or more personas related to an identity of a user for use when the user interacts with one or more service providers.

### DETAILED DESCRIPTION

One embodiment disclosed herein is related to computing systems, computer program products, and methods for using a persona as an identity of a user when the user interacts with one or more service providers. In the embodiment an identity of a user who is to interact with various service providers is verified. Various different personas related to the identity of the user are accessed. Each individual persona of the different personas includes user information related to the identity of the user. A specific one of the various different personas is selected for use in interacting with a service provider. The selected persona is provided to thereby enable the user to interact with the service provider using the selected persona.

Another embodiment disclosed herein is related to computing systems, computer program products, and methods for generating one or more personas related to an identity of a user for use when the user interacts with one or more service providers. In the embodiment, different personas are generated that are to be used by a user when interacting with various service providers. Each of the different personas are related to an identity of the user. For each individual persona of the different personas, user information related to the user that is to be included in the individual persona is selected.

For example, conventional identity management systems typically require that a user have a separate account with an identity provider for each service provider the user wants to interact with. The identity provider and/or the service provider then determines what types of user credentials and other user information about the user that the user must provider in order to gain access to a service provider associated with the identity provider. Thus, it is the identity provider and/or the service provider who dictate how the user is to be represented when interacting with the service provider. In addition, it is the service provider who typically controls the operation of the identity provider.

Such conventional systems thus provide many disadvantages to the user. For example, because the user typically is required to set up a separate account for each service provider, he or she must remember the different user credentials and other user information that is required for interaction with each service provider. This can often be a challenge for the user, especially for an account with a service provider that is rarely used. In addition, because the identity provider and/or the service provider determines what types of user information is required before interaction is allowed, privacy issues may be raised as user may have to provide user information about the user that he or she would not choose to provide if not required to.

In the embodiments disclosed herein, the user is able to implement a trusted identity provider that is under his or her control. The trusted identity provider may be implemented on a distributed network such as the Blockchain. The user may then be able to use the trusted identity provider to generate a number of different personas for use in interacting with various service providers. The different personas may each include different amounts of user information as determined for the user. In some embodiments, a user interface may allow the user to select the personal information to include in each persona.

For example, a first persona may be a non-anonymous persona that includes a relatively large amount of user information and may be used as a default persona for interactions where the user wants the service providers to know his or her identity or at least does not care if they determine the identity from the large amount of user information. A second persona may be a semi-anonymous persona that includes less user information and may be used for interactions where the user may not care whether the service provider to knows or does not know his or her identity. A third persona may be a fully anonymous persona that includes little or no user information and is used for interactions where the user does not want the service providers to know his or her identity. A fourth persona may be based on a type of the service provider and may include user information based on the type. For example, a persona for interaction with a job search service provider may include user information related to job experience and educational experience.

The embodiments related herein allow the user to use the trusted identity provider to select which persona to use when interacting with a given service provider. In some embodiments, a user interface may allow the user to select the persona or to create a new persona or modify an existing persona when requesting interaction with a service provider. In other embodiments, the user may link a persona to a service provider so that the persona is automatically selected, or a persona may be automatically selected based on past selection of the persona. The selected persona may then be used to represent the user when interacting with the service provider.

This represents a technical advance over existing identity management systems as the user is now fully in control of how he or she is represented to a service provider as the user is able to determine what user information to provide to the service provider. In addition, the embodiments disclosed herein provide an improvement to a computing system as the user no longer needs to maintain multiple accounts and user credentials with multiple identity providers and service providers. This represents a practical improvement as processing and memory resources are saved and user experience and timeliness are improved.

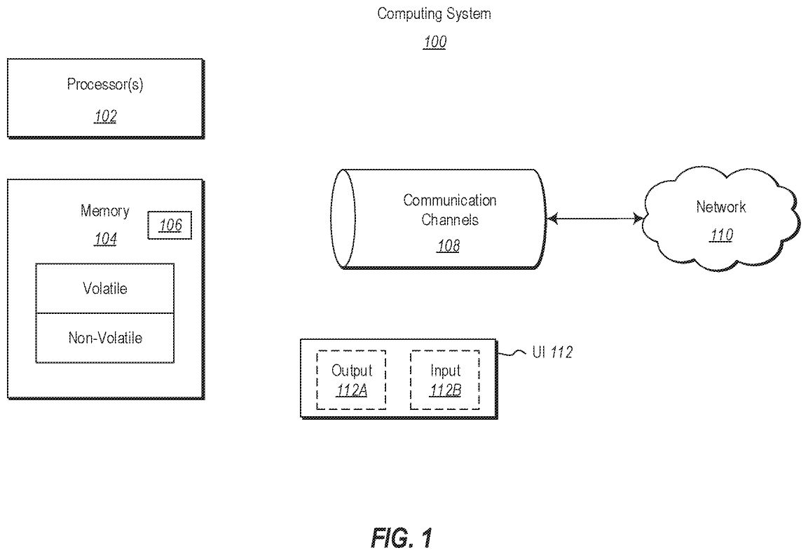

Because the principles described herein may be performed in the context of a computing system, some introductory discussion of a computing system will be described with respect to FIG. 1. Then, this description will return to the principles of the of the embodiments disclosed herein with respect to the remaining figures.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The processing unit 102 may include a general purpose processor and may also include a field programmable gate array (FPGA), an application specific integrated circuit (ASIC), or any other specialized circuit. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard coded or hard wired logic gates. The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RANI within a network interface module (e.g., a “NIC”), and then eventually transferred to computing system RANI and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing systems which may correspond to the computing system 100 previously described. The computing systems of the remaining figures include various components or functional blocks that may implement the various embodiments disclosed herein as will be explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems of the remaining figures may include more or less than the components illustrated in the figures and some of the components may be combined as circumstances warrant.

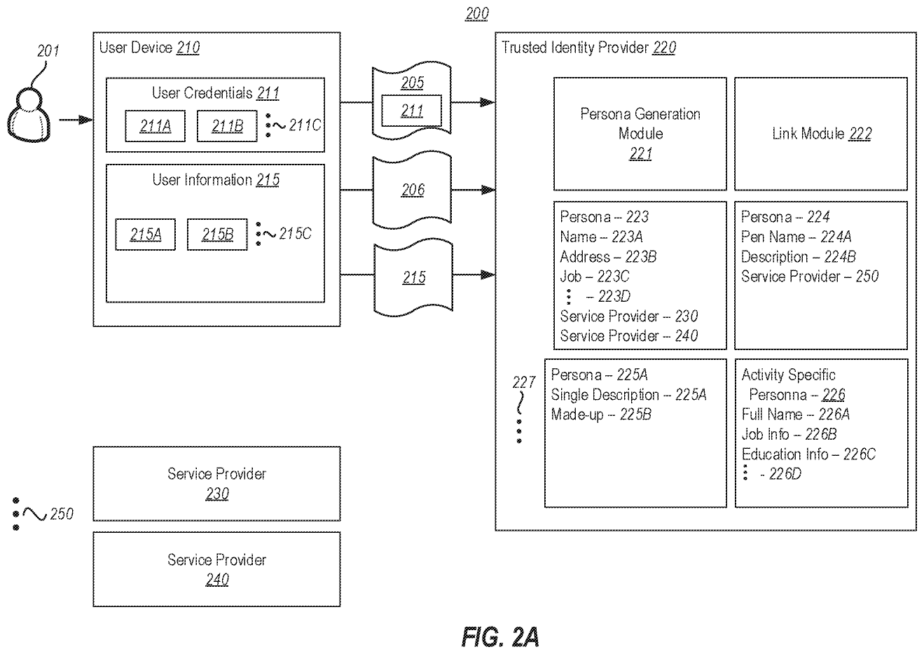

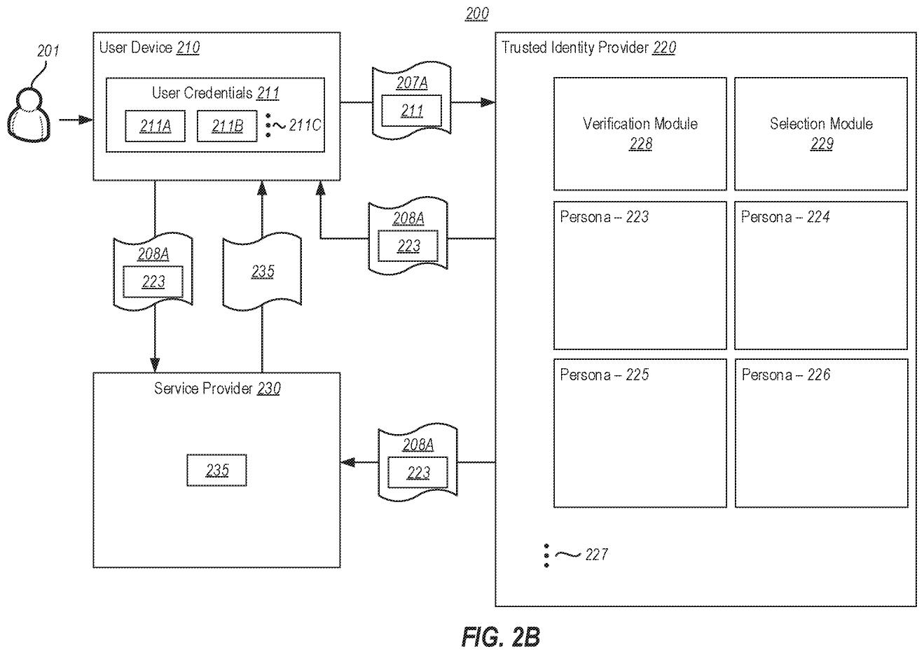

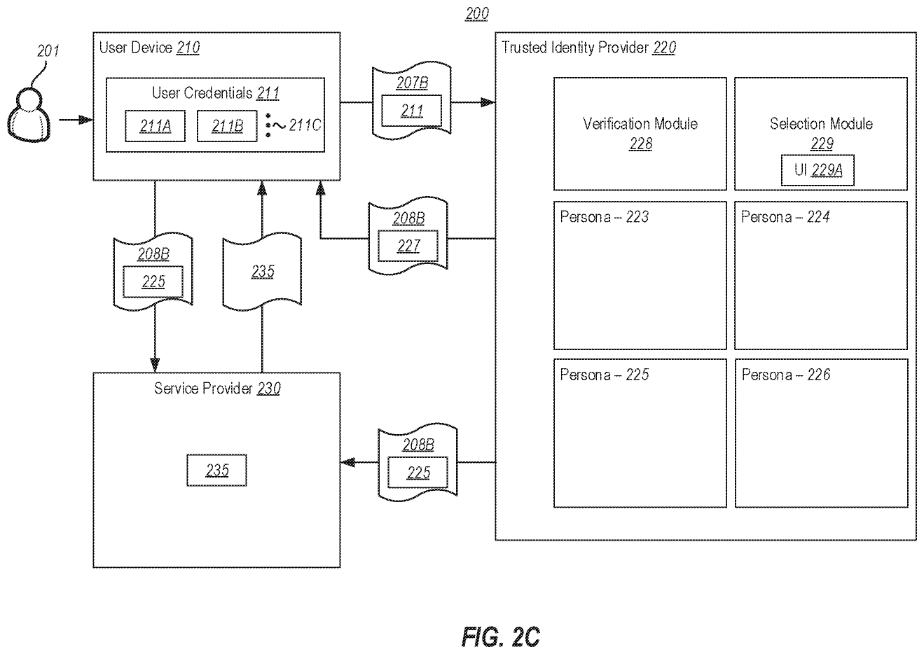

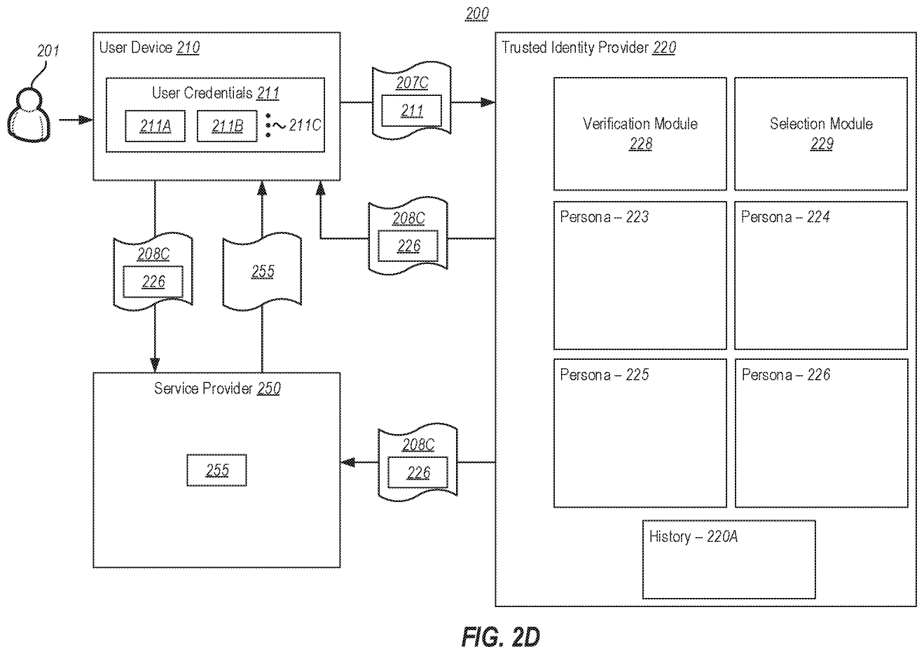

FIG. 2A illustrates a computing system environment 200 according to one embodiment disclosed herein. As illustrated, the environment 200 includes a user device 210 that is associated with a user 201, a trusted identity provider 220, a service provider 230, a service provider 240, and any number of additional service providers as illustrated by the ellipses 250. In an embodiment, the user 201 may desire to interact with one or more of the service providers 230, 240, and/or potentially 250. As will be explained in more detail, the user 201 may utilize the trusted identity provider 220 to obtain identity verification that will allow the user to interact with the service providers 230, 240, and/or potentially 250. Although the user 201 is described herein as being a human user, in some embodiments the user 201 may be a non-human user as circumstances warrant.

As mentioned, the user device 210 may be associated with or otherwise under the control of the user 201. The user device 210 may be any type of reasonable device such as, but not limited to, a mobile phone, other mobile device, or any type of computing device. The user device 210 may store or otherwise have access to user credentials 211. The user credentials 211 may include a first user credential 211A, a second user credential 211B, and any number of additional user credentials as illustrated by the ellipses 211C. As will be explained in more detail to follow, user credentials 211 may be used by the trusted identity provider 220 to verify the identity of the user 201. In some embodiments, the user credentials 211 may include a username and password. In other embodiments, the user credentials 211 may include biometric elements such as a fingerprint or a retinal scan. Of course, the user credentials may include any combination or type of credentials as circumstances may warrant.

The user device 210 may have access to user information 215. In some embodiments, the user information 215 may be stored on the user device 210. In other embodiments, the user device 210 may access the user information from a personal identity hub or other storage associated with the user 201 or from a storage of a third party. Accordingly, the inclusion of the user information 215 in the user device 210 is for ease of illustration only.

The user information 215 may include any information about the user 201. For example, the user information 215 may include personally identifiable information such as the name, address, occupation (e.g., a schoolteacher, an FBI agent, an attorney, etc.), family members (e.g., name of spouse, name of children), age (e.g., over 21 years of age), hobbies, interests (e.g., a volunteer for a particular charity organization, an employee of a particular corporation, an award winner of a particular award), or the like of the user 201.

The user information 215 may also include information that is signed by a third party that attests or verifies information about the user 201. For example, the signed information may include (but not be limited to) a qualification, an achievement, a government ID, a government right such as a passport or a driver's license, a payment provider or bank account, a university degree, a work history, or any other information about the user 201's background.

The service providers 230, 240, and 250 may be different services that the user 201 may interact with. For example, the service provider 230 may be a social media provider that the user 201 may interact with in order to post social updates. The service provider 240 may be a provider who the user 201 interacts with when looking for a job. One of the service providers 250 may be an educational institution that the user 201 attends, while another one of the service providers 250 may be a governmental department such as the DMV that the user 201 interacts with. Thus, the embodiments disclosed herein are not limited by the particular type of the service providers 230, 240, and 250.

In conventional systems, the user 201 may be issued a set of user credentials 211 by each of the service providers. These user credentials would then be submitted to an identity provider that is typically under the control of the service provider for identity authentication before the user 201 would be able to interact with the service provider. Thus, the user 201 is often forced to have separate accounts with each service provider, which can be inconvenient for the user 201 as he or she must remember each different account and the different user credentials needed to interact with each account. In addition, it is the service provider that often determines what type of user information it wants the user 201 to provide before it will interact with the user. This often means that the user 201 must provide user information that he or she would not like to provide before interacting with the service provider.

Advantageously, the embodiments disclosed herein provide for the user 201 to implement various personas or profiles that are tied to his or her identity. In this way, the user 201 is able to control what user information is provided to a service provider when he or she interacts with the service provider. In addition, the user 201 potentially only need remember a small number (potentially only one) user credential for interacting with multiple service providers.

As mentioned previously, the computing system environment 200 may include the trusted identity provider 220. In the disclosed embodiments, the trusted identity provider 220 may be considered a “trusted identity provider” in that it is trusted by both the user 201 and the service providers 230, 240, and 250. For example, in one embodiment the trusted identity provider 220 may be implemented on or backed by a distributed network such as the Blockchain. In such embodiment, the user 201 would have control over the trusted identity provider 220, in contrast to conventional systems where the service providers would each typically control the identity provider. However, since the trusted identity provider 220 is implemented on or backed by the distributed network, the service providers 230, 240, and 250 are able to trust that the trusted identity provider 220 will properly validate the identity of the user 201 as the user 201 should be the only entity that would be in control of the trusted identity provider 220. It will be appreciated that implementing the trusted identity provider 220 on the distributed network is only one example of the many ways a trusted identity provider may be implemented. Accordingly, the embodiments disclosed herein are not limited by any particular implementation of the trusted identity provider 220.

The trusted identity provider 220 may include a persona generation module 221. In operation, the persona generation module 221 may be configured to allow the user 201 to generate one or more personas or profiles that are related to the identity of the user 201. The trusted identity provider 220 may also include a link module 222. In operation, the link module 222 may allow the user 201 to link one or more of the personas to one or more of the service providers 230, 240, and/or 250. The different personas may then be used when interacting with the service providers as will be explained in more detail to follow.

The operation of generating the various personas will now be explained. As illustrated, the user device 210 may send a request 205 to the trusted identity provider 220 to generate one or more personas. The request 205 may include one or more of the user credentials 211. For example, the request 205 may include a username and password or may include a fingerprint and/or retinal scan. Upon receipt of the request 205, a verification module 228 of the trusted identity provider 220 (see FIG. 2B) may verify the identity of the user 201 using the credentials 211. The persona generation module 221 may then allow the user 201 to provide input that causes the generation of various personas that may be used during interactions with the service providers.

For example, the persona generation module 221 may generate a first persona 223. The first persona 223 may be considered a non-anonymous persona that is used in the normal course of interaction by the user 201 because it includes a relatively large amount of user information 215 that is provided to the persona generation module 221 by the user device 210. Thus, a service provider is likely to be able to determine the identity of the user 201 from the first persona 223. For example, the first persona 223 may disclose a name 223A, an address 223B, and a job description 223C of the user 201. The first persona 223 may also include any amount of additional user information as illustrated by the ellipses 223D, such as user information that would typically be included in an interaction with a service provider. Accordingly, the first persona 223 may be used as a default persona for general use when interacting with the various service providers. That is, the first persona 223 may include the user information 215 that would generally be wanted by a service provider when interacting with the user 201.

The persona generation module 221 may also generate a second persona 224 that discloses only a relatively small amount of the user information 215 that does not fully revel the identification of the DID owner 201. In other words, the second persona 224 may typically include less user information 215 than the first persona 223. Thus, the second persona 224 may be considered a semi-anonymous persona. The small of amount of user information 215 may be focused on a specific aspect of the user 201. For example, the second persona 224 may include a pen name 224A that is specific to a description 224B of the user 201. For instance, the user 201 may be a blog writer as a description 224B and so may have a pen name 224A that is related to being a blog writer. Of course, the second persona 224 may include other limited identifying information such as only a job title. Thus, the second persona 224 may be used when the user 201 only wants to provide a limited amount of user information 215 during an interaction with a service provider that may or may not result in the service provider knowing the true identity of the user 201.

The persona generation module 221 may also generate a third persona 225 that discloses little or no user information 215 and thus includes less user information 215 than both the first persona 223 and the second persona 224. Thus, the third persona 225 may be considered a fully anonymous persona. For example, the third persona 225 may only include a single description 225A about the user 201, such as job title or other background data (e.g., a school teacher, an FBI agent, an adult older than 21 years old) that is unlikely to fully identify user 201 since the single description 225A may apply to many users. Alternatively, the second persona 225 may include made-up information 225B such as a made up name or other related information that may be used so that it is very hard to determine the identity of the user 201. Thus, the third persona 225 may be used when the user 201 does not want to disclose his or her true identity during an interaction with the service provider.

The personal generation module 221 may also generate a fourth persona that is an activity specific persona 226 that is based on a specific activity or the like of the user 201. For example, the activity specific persona 226 may be a job search persona that is related to the fact that the user 201 is looking for a job and includes user information 215 that is likely useful in a job search. Accordingly, the job search persona 226 may include a full name 226A that is used by the user 201 when he or she is looking for a job, job information 226B that describes employment history and the type of job that is being sought, and education information 226C that describes educational history. The job search persona 226 may also include other job related information as illustrated by ellipses 226D. Of course, the job search persona is only one example of the numberless other activity specific personas that may be generated for the user 201.

The ellipses 227 represent that there may be any number of additional personas generated by the persona generation module 221 for the user 201. It will be appreciated that the personas 223-226 are only examples of the numerous personas that may be generated for the user 201. Accordingly, the embodiments disclosed herein are not limited by any particular type of persona.

The user 201 may desire to link at least some of the generated personas to specific service providers. In this way, whenever the user 201 interacts with the linked service providers, the linked persona will be used to represent the user 201 to the service provider. Accordingly, the user device 210 may provide user input 206 to the link module 222 that selects service providers to link to specific service providers.

For example, in one embodiment the user input 206 may cause the link module 222 to link the first persona 223 to the service provider 230 and the service provider 240. For example, the service providers 230 and 240 may be services that are frequently visited by the user 201 or that have a formal relationship with the user 201. Accordingly, the user 201 may desire that the first persona 223 be used to represent himself or herself to the service providers 230 and 240 using the relatively large amount of user information 215 included in the first persona 223.

The user input 206 may also cause the link module 222 to link the second persona 224 to one of the service providers 250. For example, the user 201 may only infrequently visit the service provider 250 or may only have a casual relationship with the service provider. Accordingly, the user 201 may desire that the second persona 224 be used to represent himself or herself to the service provider 240 using the relatively smaller amount of user information 215 included in the second persona 224.

The user 201, however, may not desire that all of the persona be linked to any specific service providers. For example, the user 201 may desire to select use of the third persona 225 at the time he or she wants to interact with a service provider 250 that he or she has never visited before or that he or she does not want to know his or her true identity. In the case of the activity specific persona 226, the user 201 may only use this persona when accessing service providers that are related to the specific activity, such as a job search service provider. Thus, there may be no need to link these personas to any specific service provider. As will be explained in more detail to follow, the user 201 may select use of the personas 225 and 226 for interaction with various service providers at the time of the interaction. In addition, although the personas 223 and 224 are linked to specific service providers, these personas may also be selected for interaction with additional service providers at the time of the interaction.

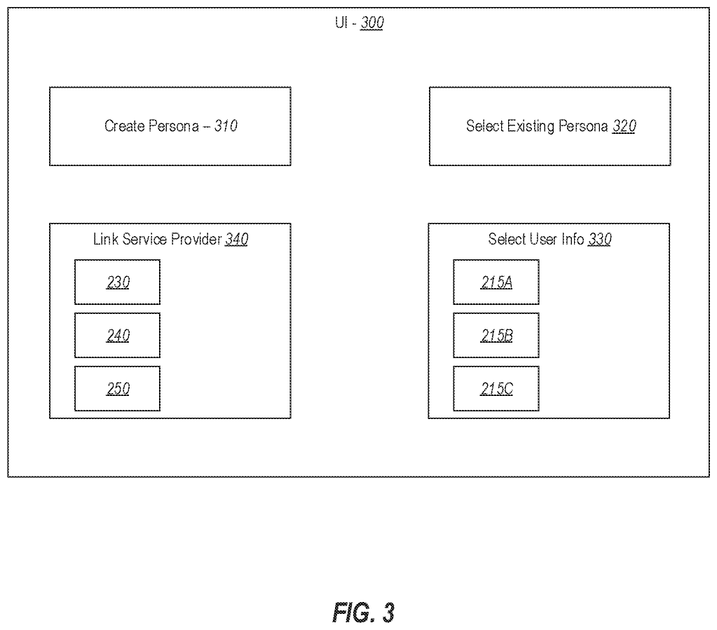

FIG. 3 illustrates an example embodiment of a user interface (UI) 300 that may be implemented by the trusted service provider 220 for generating the various personas and linking the personas to various service providers. It will be appreciated that the UI 300 illustrates one of numerous ways that a user interface may be implemented by the trusted service provider 220.

As illustrated, the UI 300 includes various UI elements such as hot buttons that may receive the user input 205 and/or 206 from the user device 210. For example, a UI element 310 may allow the user 201 to begin the process of creating or generating a new persona while a UI element 320 may allow the user 201 to modify or edit an existing persona. Regardless of whether the persona is being created or modified, a UI element 330 may allow the user 201 to select which user information 215 to include in the persona. As illustrated, the user 201 may select user information 215A, 215B, and/or 215C to include in the new or modified persona. A UI element 340 may allow the user 201 to select which service providers (if any) to link to a persona. As illustrated, the user 201 may select service provider 230, 240, and/or 250 to be linked to the new or modified persona.

FIG. 2B further illustrates the embodiment of the computing system environment 200. Accordingly, all of the elements illustrated in FIG. 2A may not be illustrated in FIG. 2B. As shown in FIG. 2B, the user 201 may desire to interact with the service provider 230. Accordingly, the user device 210 may send a request 207A to the trusted identity provider 220 that includes one or more of the user credentials 211. For example, the request 207A may include a username and password of the user 201 or it may include the biometric element such as a fingerprint or retinal scan. The verification module 228 may then verify the identity of the user 201 using the user credentials 211. Upon verification of the user credentials, the trusted identity provider 220 is able to establish the identity of the user 201.

A selection module 229 of the trusted identity provider 220 may then access the personas 223-227 and select one of the personas 223-227 that will represent the user 201 during the interaction with the service provider 230. As discussed previously, the persona 223 may have been linked to the service provider 230 by the user 201. Accordingly, the selection module 229 may automatically select the persona 230 and its included user information 215 for interaction with the service provider 230 based on the linkage.

The trusted identity provider 220 may then generate access information 208A that includes the selected persona 223. The access information 208A may include the information needed so that the service provider 230 may agree to interact with the user device 210 and the user 201. In some embodiments, the access information 208A (and all other access information discussed herein) may be an access token or the like. As illustrated, in some embodiments the access information 208A may first be sent to the user device 210, which may then provide the access information 208A to the service provider 230. In other embodiments, the trusted identity provider 220 may directly provide the access information 208A to the service provider 230.

Upon receipt of the access information 208A, the service provider 230 may use the information to grant access to the user 201. The service provider 230 may then begin to interact with the user device 210 by providing data 235 to the user device. Advantageously, the user 201 is represented to the service provider 230 by the persona 223. Thus, the service provider 230 only knows the user information 215 that is included in the persona.

FIG. 2C further illustrates the embodiment of the computing system environment 200. Accordingly, all of the elements illustrated in FIGS. 2A and 2B may not be illustrated in FIG. 2C. As shown in FIG. 2C, the user 201 may desire to interact with the service provider 230. Accordingly, the user device 210 may send a request 207B to the trusted identity provider 220 that includes one or more of the user credentials 211. The verification module 228 may then verify the identity of the user 201 using the user credentials 211. Upon verification of the user credentials, the trusted identity provider 220 is able to establish the identity of the user 201. In the embodiment of FIG. 2C, the selection module 229 may include a UI 229A that allows the user 201 to provide input that selects which persona to use in response to the request 207B.

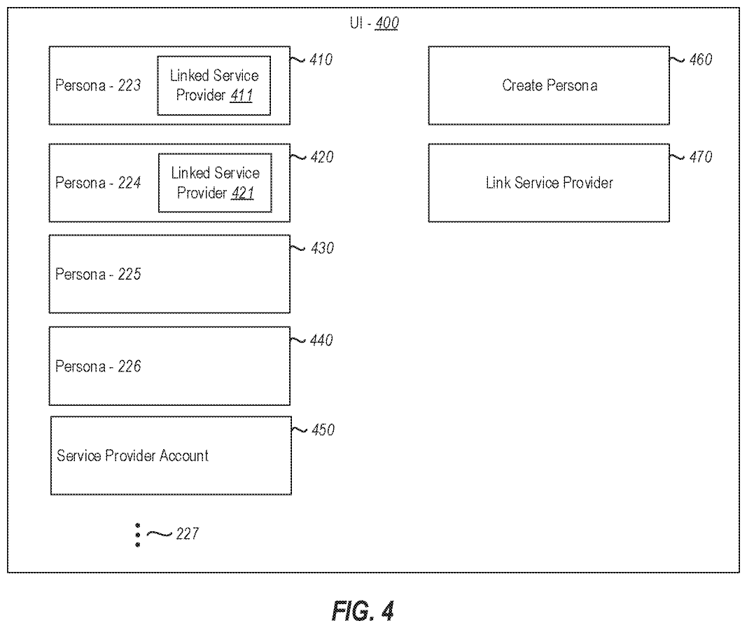

FIG. 4 illustrates an example embodiment of a UI 400 that may correspond to the UI 229A. As illustrated, the UI 400 includes a UI element 410 that lists the persona 223, a UI element 411 that accesses the service providers linked to the persona 223, a UI element 420 that lists the persona 224, a UI element 421 that accesses the service providers linked to the persona 224, a UI element 430 that lists the persona 225, and a UI element 440 that lists the persona 225. The ellipses 227 represent that the UI 400 may also list any number of the additional personas 227.

In the embodiment, the user 201 may provide input via the user device 210 that selects the UI element of persona he or she wishes to use when interacting with the service provider 230. For example, if the user selects UI element 410, then the persona 223 would be selected for interaction. If the user 201 further selected UI element 411, he or she would be sent to UI 300, where the UI element 340 could be used to add new linked service providers or modify existing linked service providers. Likewise, if the UI elements 420, 430, and 440 were selected, then their respective personas would be selected for interaction, while selection of the UI element 421 would allow for additions and modifications to the linked personas in the same manner as UI element 411.

In some embodiments, the UI 300 may include a UI element 450 that is related to an existing service provider account. For example, the user 201 may have an existing account with the service provider 240. In this embodiment, the service provider 240 consents to allow the trusted identity provider 220 to utilize the nested authentication flow that would normally be performed by an identity provider under the control of the service provider 240. The use of the UI element 450 provides convenience to the user 201 as he or she is able to use the customary log in process of his or her account with service prover 240 using the trusted service provider 220 rather than having to interact with a separate identity provider specified by the service provider 240.

The UI 400 also includes a UI element 460 that allows the user 201 to create or generate a new persona. For example, although in the embodiments previously discussed a persona already existed, this need not be the case. In some instances, the user 201 may have no existing personas. Alternatively, the user 201 may simply not want to use one of his or her existing personas for interacting with the service provider 230 because the existing personas include user information 215 that the user 201 does not want to provide to the service provider 230. Accordingly, use of the UI element 460 allows the user 201 to create a persona at the time of the request 207B. In one embodiment, selecting the UI element 460 may cause the user 201 to be sent to the UI 300, where the new persona may be created using the UI element 310 in the manner previously described. Thus, the user 201 is able to create a new persona at any time as needed.

The UI 400 may also include a UI element 470 that allows the user 201 to link one or more service providers to the various different personas. For example, the user 201 may decide to link the persona 226 to a specific service provider, even though the persona 226 was not previously linked to any service providers. The user 201 may also desire to link the persona 223 or the persona 224 to additional service providers or to modify or cancel any existing links to service providers. Accordingly, use of the UI element 470 allows the user to link one or more of the personas to various service providers at the time of the request 207B. In one embodiment, selecting the UI element 470 may cause the user 201 to be sent to the UI 300, where the service providers may be linked using the UI element 340 in the manner previously described. Thus, the user 201 is able to create and modify links to service providers at any time as needed.

Returning to FIG. 2C, the user 201 may use the UI 229A to select the persona 225 to represent the user 201 during interaction with the service provider 230. The trusted identity provider 220 may then generate access information 208B that includes the selected persona 225. The access information 208B may include the information needed so that the service provider 230 may agree to interact with the user device 210 and the user 201. As illustrated, in some embodiments the access information 208B may first be sent to the user device 210, which may then provide the access information 208B to the service provider 230. In other embodiments, the trusted identity provider 220 may directly provide the access information 208B to the service provider 230. Upon receipt of the access information 208B, the service provider 230 may use the information to grant access to the user 201. The service provider 230 may then begin to interact with the user device 210 by providing data 235 to the user device.

FIG. 2D further illustrates the embodiment of the computing system environment 200. Accordingly, all of the elements illustrated in FIGS. 2A, 2B and 2C may not be illustrated in FIG. 2D. As shown in FIG. 2D, the user 201 may desire to interact with a service provider 250, which in this instance may be a job search service provider or the like. Accordingly, the user device 210 may send a request 207C to the trusted identity provider 220 that includes one or more of the user credentials 211. The verification module 228 may then verify the identity of the user 201 using the user credentials 211. Upon verification of the user credentials, the trusted identity provider 220 is able to establish the identity of the user 201.

In this embodiment, the selection module 229 may be configured to automatically select a persona based on the service provider that the user 201 desires to interact with. Since the service provider 250 is a job search service provider, the selection module 229 may automatically select the activity specific persona 226 that is configured as a job search persona as previously described. In other words, since the activity specific persona 226 matches or at least is related to the activity of the service provider (i.e., job search), the selection module 229 may automatically determine that the user 201 would likely want to interact with the service provider using the activity specific persona 226. Of course, there may be more than one persona that matches or is at least related to the specific activity of the service provider. In such case, a UI such as UI 229A may list all the persona that are related to the specific activity of the service provider and allow the user 201 to select which one to use.

The trusted identity provider 220 may then generate access information 208C that includes the selected persona 226. The access information 208C may include the information needed so that the service provider 250 may agree to interact with the user device 210 and the user 201. As illustrated, in some embodiments the access information 208C may first be sent to the user device 210, which may then provide the access information 208C to the service provider 250. In other embodiments, the trusted identity provider 220 may directly provide the access information 208C to the service provider 250. Upon receipt of the access information 208C, the service provider 250 may use the access information to grant access to the user 201. The service provider 250 may then begin to interact with the user device 210 by providing data 255 to the user device.

In some embodiments, the trusted identity provider 220 may include a history 220A. In operation, the selection module 229 may store in the history 220A which persona was selected by the user 201 when interacting with a specific service provider. If the trusted identity provider 220 subsequently receives a request for access to that service provider, then the selection module 229 may automatically select the persona stored in the history 220A. Alternatively, the selection module 229 may use a UI such as the UI 229A to provide a suggestion to the user 201 to use the persona stored in the history 220A since this persona was used in the past. The user 201 would then be able to select the persona stored in the history 220A or select another persona as circumstances warranted.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

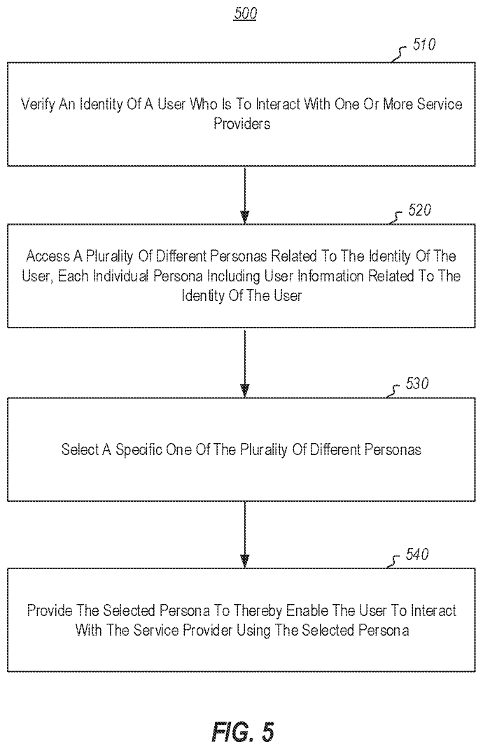

FIG. 5 illustrates a flow chart for an example method 500 for using a persona as an identity of a user when the user interacts with one or more service providers. The method 500 will be described with respect to one or more of FIGS. 2A-2D, 3 and 4 discussed previously.

The method 500 includes verifying an identity of a user who is to interact with one or more service providers (510). For example, as previously described the trusted identity provider 220, specifically the verification module 228, may verify the identity of the user 201 in response to the request 207 to interact with one of the service providers 230, 240, and potentially 250. In some embodiments, the verification is performed by verifying one or more of the user credentials 211 such as a username and password or a biometric element such as a fingerprint or retinal scan.

The method 500 includes accessing a plurality of different personas related to the identity of the user, each individual persona of the plurality of different personas including user information related to the identity of the user (520). For example, as previously described, the trusted identity provider 220, specifically the selection module 229, may access the personas 223, 224, 225, 226, and potentially 227. Each of these personas may include an amount of user information 215 (i.e., user information 215A, 215B, and potentially 215C) as determined by the user 201.

The method 500 includes selecting a specific one of the plurality of different personas for use in interacting with a service provider (530). For example, as previously described, the trusted identity provider 220, specifically the selection module 229, may select one of the personas 223, 224, 225, 226, and potentially 227. The selection may be based on how much user information 211 the user desires to provide to the service provider or on the type of the service provider.

The method 500 includes providing the selected persona to thereby enable the user to interact with the service provider using the selected persona (540). For example, as previously described, the trusted identity provider 220 may provide the selected persona 223, 224, 225, 226, or 227 to the service provider 230, 240, or 250 as illustrated by 208, either directly or via the user device 210.

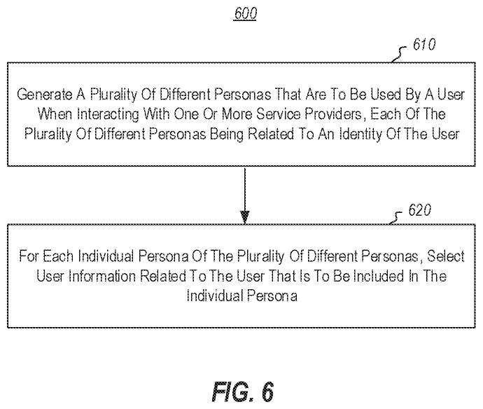

FIG. 6 illustrates a flow chart for an example method 600 for generating one or more personas related to an identity of a user for use when the user interacts with one or more service providers. The method 600 will be described with respect to one or more of FIGS. 2A-2D, 3 and 4 discussed previously.

The method 600 includes generating a plurality of different personas that are to be used by a user when interacting with one or more service providers, each of the plurality of different personas being related to an identity of the user (610). For example, as previously described, the trusted identity provider 220, specifically the persona generation module 221, may generate one or more of the personas 223, 224, 225, 226, and potentially 227 for interaction with one or more of the service providers 230, 240, and 250. As described herein, the personas are related to the identity of the user 201 since the personas will be used to represent the user 201 to the service providers. That is, the persona will define how the user 201 is presented to the service provider and will also include how much information about the user 201 is presented to the service provider.

The method 600 includes, for each individual persona of the plurality of different personas, selecting user information related to the user that is to be included in the individual persona (620). For example, as previously described, the trusted identity provider 220, specifically the persona generation module 221, may include an amount of user information 215 (i.e., user information 215A, 215B, and potentially 215C) as determined by the user 201. As previously discussed, the service provider that the user 201 is interacting with will only see the user information included in the persona. Advantageously, the service provider is unable to access any user information 211 not included in the persona, which allows the user 201 to have control over what types and how much user information is provided to the service provider.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, when executed by the one or more processors, cause the computing system to:
verify an identity of a user who is to interact with one or more service providers;
access a plurality of different personas related to the identity of the user, each individual persona of the plurality of different personas including user information related to the identity of the user;
select a specific one of the plurality of different personas for use in interacting with a service provider; and
provide the selected persona to thereby enable the user to interact with the service provider using the selected persona.

2. The computing system in accordance with claim 1, wherein selecting a specific one of the plurality of different personas comprises:
receiving input from the user that selects the specific one of the plurality of different personas to use when interacting with the specific service provider.

3. The computing system in accordance with claim 2, wherein the user input is received into a user interface that is configured to show to the user the plurality of different personas.

4. The computing system in accordance with claim 1, wherein selecting a specific one of the plurality of different personas comprises:
selecting a specific one of the plurality of different personas that has been linked to the specific service provider by the user.

5. The computing system in accordance with claim 1, wherein selecting a specific one of the plurality of different personas comprises:
automatically selecting a specific one of the plurality of different personas based on a type of the specific service provider.

6. The computing system in accordance with claim 1, wherein selecting a specific one of the plurality of different personas comprises:
automatically selecting a specific one of the plurality of different personas based on past selection of the one or more plurality of different personas.

7. The computing system in accordance with claim 1, wherein verifying the identity of the user comprises validating one or more credentials received from a user.

8. The computing system in accordance with claim 7, wherein the one or more user credentials comprise one or more of a username, a password, and a biometric element.

9. The computing system in accordance with claim 1, wherein the plurality of personas include a non-anonymous persona that includes a large amount of user information related to the identity of the user.

10. The computing system in accordance with claim 9, wherein the plurality of personas include a semi-anonymous persona that includes an amount of user information related to the identity of the user that is smaller than the amount included in the non-anonymous persona.

11. The computing system in accordance with claim 10, wherein the plurality of personas include an anonymous persona that includes an amount of user information related to the identity of the user that is smaller than the amount included in the non-anonymous persona and the semi-anonymous persona.

12. The computing system in accordance with claim 1, wherein the plurality of personas include a persona that is related to a specific activity of the user and the persona includes user information related to the specific activity.

13. A computing system comprising:
one or more processors; and
one or more computer-readable media having thereon computer-executable instructions that are structured such that, when executed by the one or more processors, cause the computing system to:
generate a plurality of different personas that are to be used by a user when interacting with one or more service providers, each of the plurality of different personas being related to an identity of the user; and
for each individual persona of the plurality of different personas, select user information related to the user that is to be included in the individual persona.

14. The computing system in accordance with claim 13, wherein the executed computer-executable instructions further cause the computing system to:
link the one or more service providers to one or more of the plurality of different personas.

15. The computing system in accordance with claim 14, wherein linking the one or more service providers to one or more of the plurality of different personas comprises:
receiving user input that selects the one or more service providers that are to be linked to the one or more plurality of different personas.

16. The computing system in accordance with claim 15, wherein the user input is received into a user interface that is configured to allow the user to select the one or more service providers that are to be linked to the one or more plurality of different personas.

17. The computing system in accordance with claim 13, wherein selecting the user information comprises:
receiving input from the user that selects the user information to that is to be included in each individual persona of the plurality of different personas.

18. The computing system in accordance with claim 15, wherein the user input is received into a user interface that is configured to allow the user information to that is to be included in each individual persona of the plurality of different personas.

19. A method for using a persona as an identity of a user when the user interacts with one or more service providers, the method comprising:
verifying an identity of a user who is to interact with one or more service providers;
accessing a plurality of different personas related to the identity of the user, each individual persona of the plurality of different personas including user information related to the identity of the user;
selecting a specific one of the plurality of different personas for use in interacting with a service provider; and
providing the selected persona to thereby enable the user to interact with the service provider using the selected persona.

20. The method of claim 19, wherein selecting a specific one of the plurality of different personas comprises one of:
receiving input from the user that selects the specific one of the plurality of different personas to use when interacting with the specific service provider, selecting a specific one of the plurality of different personas that has been linked to the specific service provider by the user, and automatically selecting a specific one of the plurality of different personas.
